(19) United States
(12) Patent Application Publication
(10) Pub. No.: US 2013/0303835 A1
(43) Pub. Date: Nov. 14, 2013

(54) Microactuator

(71) Applicant: Gregory N. Koskowich, Plesanton, CA (US)

(72) Inventor: Gregory N. Koskowich, Plesanton, CA (US)

(73) Assignee: OtoKinetics Inc., Salt Lake City, UT (US)

(21) Appl. No.: 13/468,983

(22) Filed: May 10, 2012

(51) Int. Cl. H04R 25/00

(52) U.S. Cl. CPC H04R 25/00; H04R 25/604
USPC 600/25; 29/25.35

(57) ABSTRACT

A microactuator has a proximal end configured to receive an electrical signal and a distal end configured to be inserted into a fenestration of an otic bone to provide access through the lateral wall of the cochlea of a subject. The microactuator includes a piezoelectric transducer assembly having a piezoelectric transducer disposed on a membrane (the piezoelectric transducer having a smaller dimension than a corresponding dimension of the membrane), a hermetically sealed fluid cavity filled with a fluid sealed at a first end to a first side of the piezoelectric transducer assembly and at a second end to a diaphragm, a second cavity containing a vacuum or a gas sealed at a first end to a second side of the piezoelectric transducer assembly and at a second end to an end cap.

### TECHNICAL FIELD

This disclosure relates generally to microactuators (sometimes referred to as transducers). More particularly it relates to microactuators for use with fully implantable hearing aid systems.

### BACKGROUND

Various different types of semi-implantable and fully-implantable hearing aids have been developed or proposed over the years. Cochlear implants utilize a direct electrical stimulation of the human cochlea in order to convey a perceivable signal to a human subject. Middle ear implants use mechanical stimulation of the ossicles or middle ear bones to convey a perceivable signal to a human subject. Air conduction hearing aids use a speaker element to create perceivable sound pressure signals in the air of the ear. Some implantable hearing aids have used a piezoelectric stack or pre-stressed piezoelectric materials to form a piezoelectric transducer having sufficient displacement to convey a perceivable signal to a human subject. See, for example, U.S. Pat. Nos. 5,772,575 (“Implantable Hearing Aid”) and 6,561,231 (“Method for filling acoustic Implantable Transducers”) and U.S. Patent Application Publication Documents US2002/0062875A1 (“Method for filling acoustic implantable transducers”) and US2003/0055311A1 (“Biocompatible Transducers”). What is needed is an improved fully implantable hearing aid microactuator.

### OVERVIEW

A microactuator has a proximal end configured to receive an electrical signal and a distal end configured to be inserted into a fenestration of an otic bone to provide access through the lateral wall of the cochlea of a subject. The microactuator includes a piezoelectric transducer assembly having a piezoelectric transducer disposed on a membrane (the piezoelectric transducer having a smaller dimension than a corresponding dimension of the membrane), a hermetically sealed fluid cavity filled with a fluid sealed at a first end to a first side of the piezoelectric transducer assembly and at a second end to a diaphragm, a second cavity containing a vacuum or a gas sealed at a first end to a second side of the piezoelectric transducer assembly and at a second end to an end cap.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a front elevational drawing of a fully implantable hearing aid microactuator in an implantable sleeve in accordance with an embodiment.

FIG. 2 is a cross-sectional drawing of the fully implantable hearing microactuator in an implantable sleeve of FIG. 1 taken along line 2-2 thereof.

FIG. 3 is an exploded front perspective view of a microactuator in accordance with an embodiment.

FIG. 4 is another exploded view of the microactuator of FIG. 3 from another perspective.

FIG. 5 is a front elevational view of a microactuator in accordance with an embodiment.

FIG. 6 is a cross-sectional view of the microactuator taken along line 6-6 of FIG. 5.

FIG. 7 is a top plan view of a microactuator sleeve in accordance with an embodiment.

FIG. 8 is a cross-sectional view of the microactuator sleeve taken along line 8-8 of FIG. 7.

FIG. 9 is a cross-sectional view of the microactuator sleeve taken along line 9-9 of FIG. 7.

FIG. 10 is a top plan view of a microactuator in accordance with an embodiment.

FIG. 11 is a side elevational view of a microactuator in accordance with an embodiment.

FIG. 12 is a top plan view of a microactuator sleeve in accordance with an embodiment.

FIG. 13 is a side elevational view of a microactuator sleeve in accordance with an embodiment.

FIG. 14 is a top plan view of a microactuator situated in an implantable sleeve in accordance with an embodiment.

FIG. 15 is a cut-away view of a microactuator in accordance with an embodiment.

FIG. 16 is a process flow diagram illustrating steps for assembly of a microactuator in accordance with an embodiment.

### DESCRIPTION OF EXAMPLE EMBODIMENTS

Example embodiments are described herein in the context of a microactuator for use with a fully implantable hearing aid. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

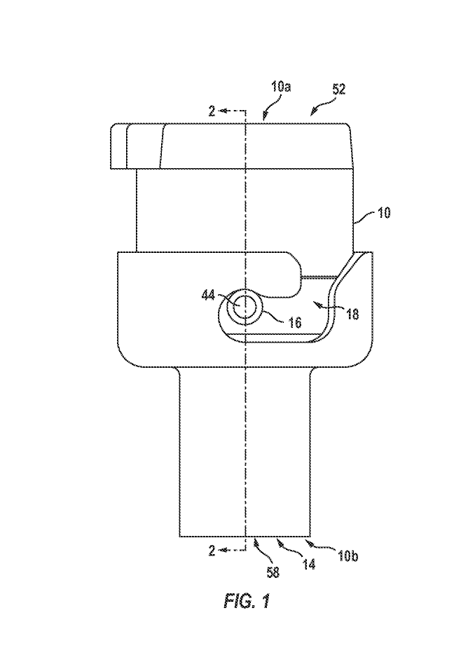

Turning to the figures, FIG. 1 is a front elevational drawing of a fully implantable microactuator 10 having a proximal end 10a and a distal end 10b in accordance with an embodiment situated in an implantable sleeve 12. The implantable sleeve may be formed in a number of ways and implanted into the head of a subject so as to receive the microactuator 10.

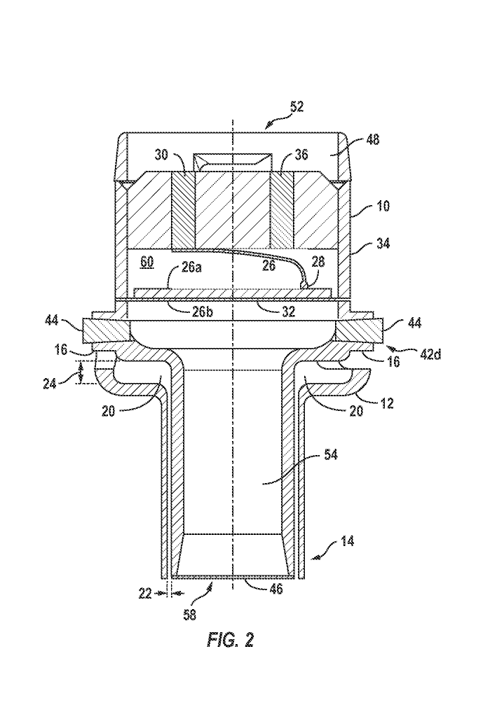

FIG. 2 is a cross-sectional drawing of the microactuator 10 and sleeve 12 of FIG. 1 taken along line 2-2 thereof. Sleeve 12 is configured to have its narrow (or distal) end 14 inserted into a hole drilled into the otic bone within the cochlea of a subject and to be held in place there with an appropriate technology (e.g., adhesives, mechanical locking, interference fit, and the like). Microactuator 10 is locked to sleeve 12 in one embodiment with a biased bayonet-type locking structure comprising one or more pins 16 extending from microactuator 10 to engage one or more corresponding receiving slots 18 of sleeve 12. A partially compressed O-ring 20 (in one embodiment fabricated of silicone) is configured to provide an outward bias between microactuator 10 and sleeve 12 to hold the pin-slot bayonet-type locking structure engaged as well as to provide a liquid-tight seal. Sleeve 12 may therefore be installed first providing a microactuator receptacle, then microactuator 10 is installed into the receptacle and replaced from time to time as required for repair, maintenance, and/or upgrades. A first gap 22 between sleeve 12 and microactuator 10 at the narrow end 14 of sleeve 12 may be, in one embodiment, about 0.05 mm. A second gap 24 between microactuator 10 and sleeve 12 in the area of compressed O-ring 20 may, in one embodiment, be about 0.24 mm (in this case with an O-ring having a nominal cross-sectional diameter of 0.051 mm and a nominal inner diameter of 1.21 mm.

Microactuator 10 further comprises a piezoelectric transducer membrane assembly 26 with a hot lead 28 coupled to a first electrical contact 30 and a ground lead 32 coupled to the case 34 of microactuator 10 and through that to a second electrical contact 36. First electrical contact 30 is insulated from case 34 of microactuator 10. Piezoelectric transducer membrane assembly 26 may comprise a cylindrical (circular axial cross-section) piezoelectric transducer 26a such as a lead zirconate titanate (PZT) crystal or stack of crystals (or other suitable piezoelectric material or materials) having a first diameter and a thin titanium membrane 26b of circular axial cross-section having a second, larger diameter to which piezoelectric transducer 26a is fixed. Making the piezoelectric transducer of smaller dimension than the membrane on which it is fixed provides an improved response by decoupling somewhat the piezoelectric transducer 26a from the case 34 through the flexible action of membrane 26b.

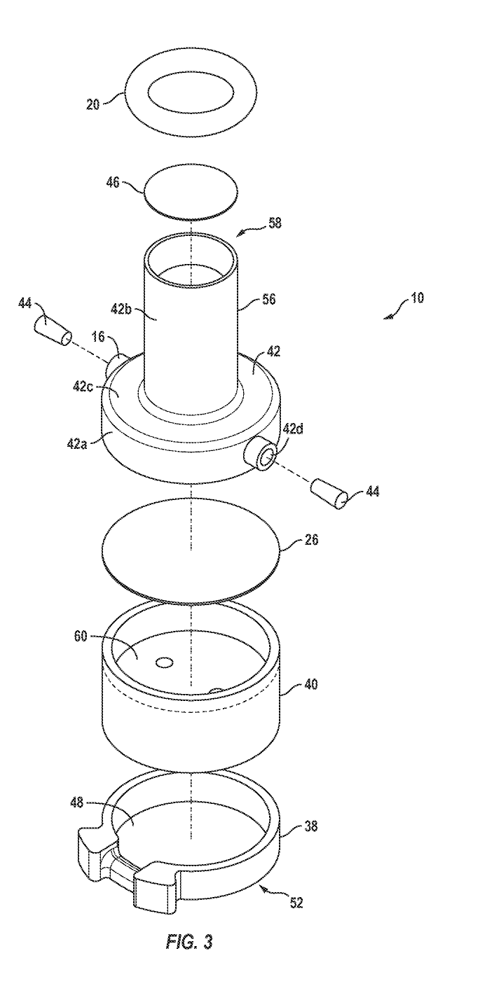

FIG. 3 is an exploded front perspective view of a microactuator 10 in accordance with an embodiment. From bottom to top the primary parts of the microactuator 10 are: feed through flange 38, microactuator end cap 40, piezoelectric transducer membrane assembly 26 (comprising piezoelectric transducer 26a and membrane 26b), microactuator flange 42 with pins 16 and plugs 44 (for plugging ports in pins 16), microactuator distal diaphragm 46 (formed in one embodiment of thin (19 um+/−1 um thick) titanium (a thickness range of about Sum to about 100 um being appropriate), and O-ring 20. Microactuator end cap 40 may be a ceramic feed-through that will form a hermetically sealed, back cavity 60 with the piezoelectric transducer membrane assembly 26 to isolate the piezoelectric transducer 26a electrically and so that it does not come into contact with the tissue of the subject. Back cavity 60 may be partially or totally evacuated or may alternatively contain a gas such as air, nitrogen, argon, helium or the like or a combination thereof. Microactuator flange 42 comprises in one embodiment a first proximal cylindrical portion 42a and a second cylindrical portion 42b coupled together, as, for example, with metal disk portion 42c. The second distal cylindrical portion 42b has a smaller diameter than the first proximal cylindrical portion 42a so that it can fit into sleeve 12 which is disposed through a fenestration in an otic bone to reach through the lateral wall of the cochlea of a subject. This arrangement allows the microactuator to stop at a predetermined amount of insertion into the sleeve which also has corresponding cylindrical portions of different diameters. The first proximal cylindrical portion 42a has a pair of ports 42d through pins 16 which allow liquid to be placed into fluid cavity 54 formed inside microactuator flange 42 and then sealed with plugs 44 as described in more detail below.

Placing the piezoelectric transducer membrane assembly 26 between the back cavity 60 and the fluid cavity 54 allows the piezoelectric transducer 26a to directly drive the relatively incompressible fluid body 54a contained in fluid cavity 54 to, in turn, drive distal diaphragm 46, the outside wall of which is in contact with the inside wall of the cochlea, to thereby impart the sensation of sound to the subject. Disposing a gas or vacuum in the back cavity 60 (on the opposite side of the piezoelectric transducer membrane assembly 26 from the fluid cavity 54) reduces resistance to the vibratory motion of the piezoelectric transducer membrane assembly 26 to improve performance and reduce power draw.

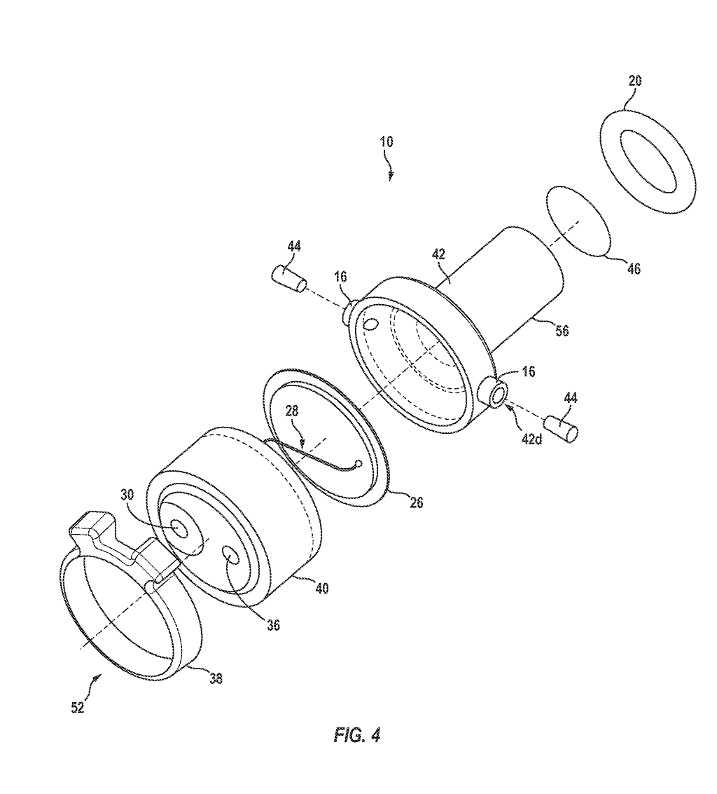

FIG. 4 is another exploded view of microactuator 10 from another perspective.

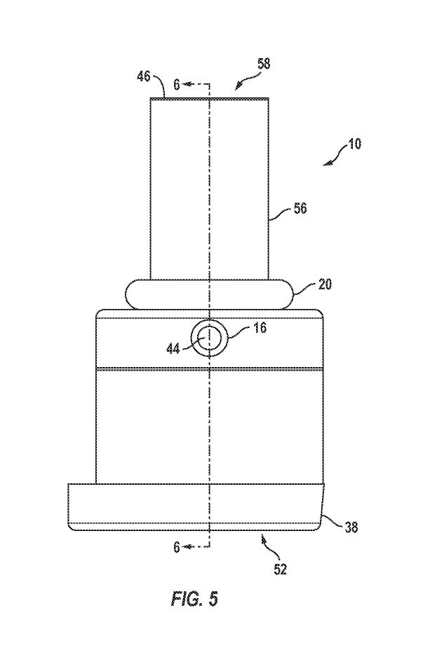

FIG. 5 is a front elevational view of microactuator 10. FIG. 6 is a cross-sectional view thereof taken along line 6-6 of FIG. 5.

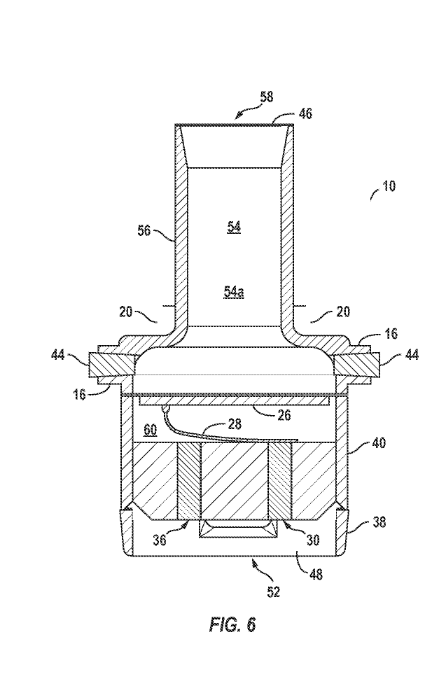

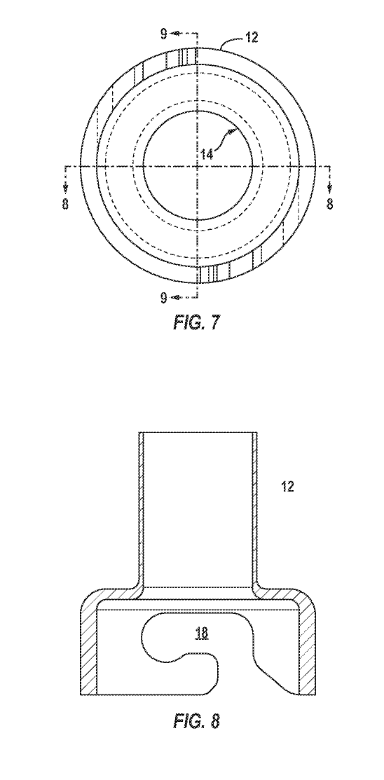

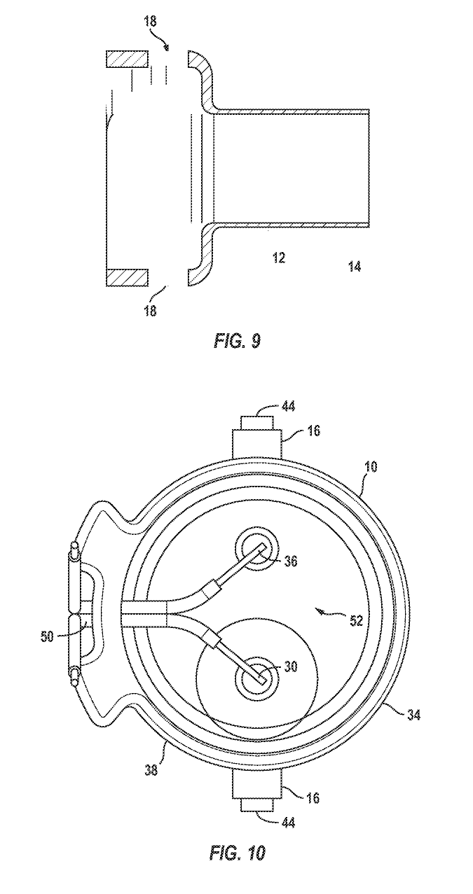

FIG. 7 is a top plan view of sleeve 12. FIG. 8 is a cross-sectional view taken along lines 8-8 of FIG. 7. FIG. 9 is a cross-sectional view taken along lines 9-9 of FIG. 7.

FIG. 10 is a top plan view of microactuator 10 in accordance with an embodiment.

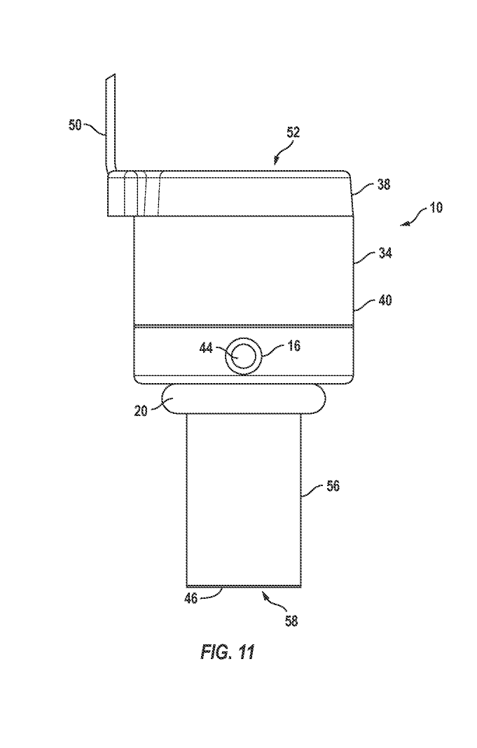

FIG. 11 is a side elevational view of microactuator 10 in accordance with an embodiment.

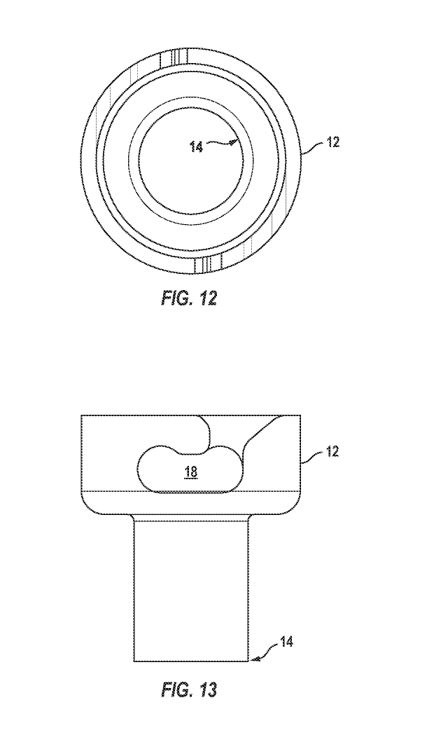

FIG. 12 is a top plan view of sleeve 12 in accordance with an embodiment.

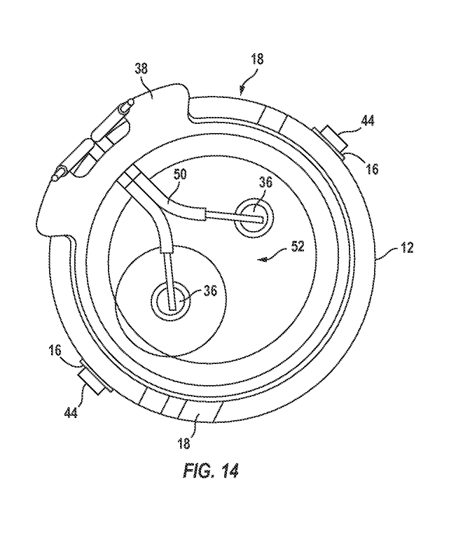

FIG. 13 is a side elevational view of sleeve 12 in accordance with an embodiment.

FIG. 14 is a top plan view of microactuator 10 situated in sleeve 12 in accordance with an embodiment.

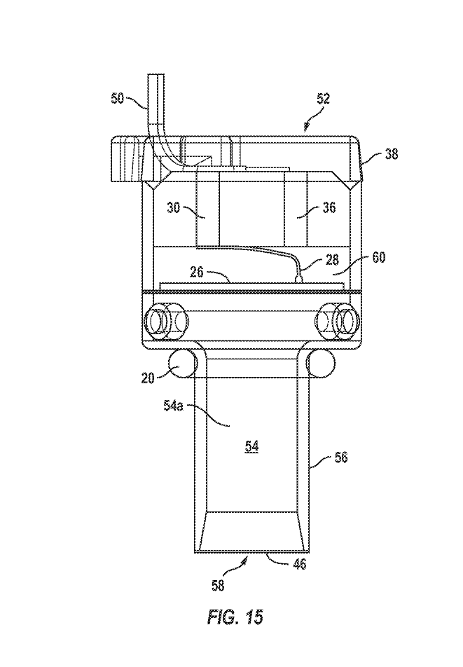

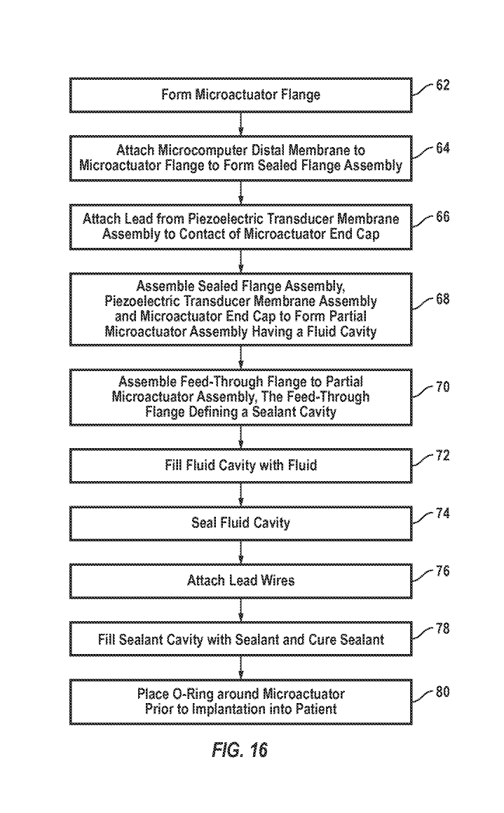

FIG. 15 is a cut-away view of microactuator 10 in accordance with an embodiment.

A sealant cavity 48 (initially open at the top) is defined at an outer periphery by the inside of feed-through flange 38 and is in one embodiment filled with a silicone sealant material (although those of ordinary skill in the art will now realize that other suitable sealant materials may be used instead). This sealant material protects first and second electrical contacts (30, 36), provides strain relief for microactuator lead wires 50 which couple microactuator 10 to other hearing aid component (not shown) and seals the proximal end 52 of microactuator 10 from moisture infiltration.

Fluid cavity 54 configured to contain fluid body 54a as discussed above is defined at an outer periphery by the inside wall of narrow portion 56 of microactuator 10, at a distal end by microactuator distal diaphragm 46 located at distal end 58 of microactuator 10, and at a proximal end by piezoelectric transducer membrane assembly 26. Fluid cavity 54 is filled with a fluid as described in more detail below in order to improve performance of the microactuator in conveying the impression of sound to the inner ear of a subject.

In one embodiment the piezoelectric transducer 26a has a thickness along a longitudinal axis in a range of from about 25 um to about 500 um with 100 um used in one example, the membrane 26b has a thickness in a range of from about 5 um to about 100 um with 25 um used in one example, and the diaphragm 46 has a thickness in a range of from about 5 um to about 100 um with 19 um+/−1 um used in one example. In one embodiment the piezoelectric transducer 26a is soldered to the membrane 26b.

FIG. 16 a process flow diagram illustrating a method for constructing microactuator 10. First (62), form microactuator flange 42 as described above out of an appropriate biocompatible material such as titanium.

Second (64), laser weld microactuator distal diaphragm 46 to the distal (narrow) end of microactuator flange 42 along the outside edge of diaphragm 46.

Third (66), attach (which may be accomplished with a laser weld) one end of hot lead (which may comprise gold such as gold wirebond) 28 to piezoelectric transducer membrane assembly 26 and a second end of hot lead 28 to first electrical contact 30 on microactuator end cap 40 which is nearest to piezoelectric transducer membrane assembly 26.

Fourth (68), assemble the sealed flange assembly (42, 46), the piezoelectric transducer membrane assembly 26 and the microactuator end cap 40 to form a partial microactuator assembly (42, 46, 26, 40). This step may be performed by sandwiching the piezoelectric transducer membrane assembly 26 with (on one side) the microactuator end cap 40 and (on the other side) the sealed flange assembly (42, 46) in a fixture to hold them together during a laser welding operation. This laser weld may be performed by rotating the fixture while welding along the intersection of the microactuator end cap 40, the piezoelectric transducer membrane assembly 26 and the sealed flange assembly (42, 46). This completes the back cavity which is a hermetically sealed cavity filled as described above and located between the piezoelectric transducer membrane assembly 26 and microactuator end cap 40. It also creates the fluid cavity 54. The back cavity may be evacuated, partially evacuated or filled with a selected gas or gasses at this time by conducting the operation in an environment which is evacuated or filled with the selected gas or gasses.

Fifth (70), mount the partial microactuator assembly (42, 46, 26, 40) and feed-through flange 38 into a fixture and perform a circumferential weld joining these two components. The feed-through flange 38 provides strain relief for the microactuator lead wires 50, defines the sealant cavity 48 and provides a retainer for the silicone sealant used to electrically isolate the connection between the microactuator lead wires 50 and microactuator end cap 40.

Sixth (72), fill the fluid cavity 54 with a fluid (which may in one embodiment be sterile water or sterile saline solution) using a vacuum process or other suitable method. In accordance with the vacuum process the microactuator assembly 10 is immersed in a container containing saline or another appropriate fluid. The container is then placed inside a vacuum chamber with one of the two ports 42d oriented facing upwardly (top port) and the other of the two ports 42d oriented facing downwardly (bottom port). When a vacuum is drawn on the vacuum chamber the air inside the microactuator fluid cavity exits from the top port and fluid enters the fluid cavity from the bottom port.

Seventh (74), seal the fluid cavity as follows. Plugs 44 are inserted into the ports 42d and laser welded to hermetically seal them. The laser welding forms a seal before the heat from the welding can appreciably heat the fluid in the fluid cavity 54. A single port 42d and corresponding plug 44 could be used as could more than two ports 42d and corresponding plugs 44 as will now be apparent to those of ordinary skill in the art having the benefit of this disclosure.

Eighth (76), attach the microactuator lead wires 50 to first and second electrical contacts (30, 36) at the outside of the microactuator. This may be performed by a laser weld.

Ninth (78), fill the sealant cavity 48 with silicone sealant material and cure it.

Tenth (80), place the silicone O-ring 20 on the narrow portion 56 of microactuator flange 42 so it is at the location where the outer diameter of the microactuator flange 42 changes from a smaller diameter to a larger diameter (as shown). O-ring 20 is configured to create a moisture-tight seal between the microactuator 10 and the sleeve 12 which holds it in place within the cochlea of the subject. This step may be performed at any time prior to installation.

While steps 1-10 above have been set forth in one order, those of ordinary skill in the art having the benefit of this disclosure will now realize that the steps could be broken down into sub-steps and that the steps and/or sub-steps may be performed in any convenient order in a production environment.

As described above, all surfaces in contact with the body of the subject may be of medical grade titanium except the medical grade silicone which may be used in the sealant cavity and Ethylene Tetrafluoroethylene (ETFE) which is a biocompatible material which may be used for insulating the microactuator lead wires 50.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A microactuator comprising:
a proximal end and a distal end, the proximal end configured to receive an electrical signal, the distal end configured to be inserted into a fenestration of an otic bone of a subject;
a piezoelectric transducer membrane assembly, the piezoelectric transducer membrane assembly including a piezoelectric transducer disposed on a membrane, the piezoelectric transducer having a smaller axial cross-sectional dimension than a corresponding axial cross-sectional dimension of the membrane;
a fluid cavity containing a fluid sealed at a first end to a first side of the piezoelectric transducer membrane assembly and at a second end to a diaphragm; and
a back cavity sealed at a first end to a second side of the piezoelectric transducer membrane assembly and at a second end to an end cap.

2. The microactuator of claim 1, wherein the back cavity is partially evacuated.

3. The microactuator of claim 1, wherein the back cavity is totally evacuated.

4. The microactuator of claim 1, wherein the back cavity contains a gas.

5. The microactuator of claim 4, wherein the gas comprises air.

6. The microactuator of claim 4, wherein the gas comprises argon.

7. The microactuator of claim 4, wherein the gas comprises nitrogen.

8. The microactuator of claim 1, wherein the piezoelectric transducer membrane assembly has a circular axial cross-section.

9. The microactuator of claim 8, wherein the piezoelectric transducer has a circular axial cross-section and the dimension is a diameter.

10. The microactuator of claim 9, wherein the membrane is circular and has a larger diameter than the diameter of the piezoelectric transducer.

11. The microactuator of claim 1, wherein the fluid comprises water.

12. The microactuator of claim 1, wherein the fluid comprises saline.

13. The microactuator of claim 1, wherein the fluid cavity and the back cavity are circular in axial cross-section.

14. The microactuator of claim 1, wherein the piezoelectric transducer has a thickness in a range of from about 25 um to about 500 um.

15. The microactuator of claim 1, wherein the membrane has a thickness in a range of from about 5 um to about 100 um.

16. The microactuator of claim 1, wherein the diaphragm has a thickness in a range of from about 5 um to about 100 um.

17. The microactuator of claim 1, further comprising:
an implantable sleeve configured for permanent insertion into a fenestration in an otic bone of a subject,
wherein the microactuator is configured to fit into and lock to the sleeve.

18. The microactuator of claim 17, further comprising an O-ring disposed about the microactuator and configured to be in contact with the microactuator and the sleeve when installed in the subject.

19. The microactuator of claim 1, further comprising:
a sealant cavity disposed at the proximal end of the microactuator and filled with a sealant; and
lead wires coupled to the microactuator within the sealant cavity.

20. The microactuator of claim 19, wherein the sealant comprises silicone.

21. The microactuator of claim 1, wherein the fluid cavity includes at least one sealable port.

22. A method for fabricating a microactuator having a proximal end and a distal end, the proximal end configured to receive an electrical signal, the distal end configured to be inserted into a fenestration of an otic bone of a subject, the method comprising:
forming a microactuator flange having a first cylindrical portion at a proximal end with a first circular axial cross-section having a first diameter, a second cylindrical portion at a distal end with a second circular axial cross-section having a second diameter smaller than the first diameter;
attaching a microactuator distal membrane to the distal end of the microactuator flange assembly to form a sealed flange assembly;
forming a piezoelectric transducer membrane assembly by attaching a piezoelectric transducer having a first circular cross-section with a first diameter to a membrane having a second circular cross-section with a second diameter, the second diameter larger than the first diameter;
attaching a lead between the piezoelectric transducer and a first electrical contact of a microactuator end cap;
assembling the sealed flange assembly, the piezoelectric transducer membrane assembly and the microactuator end cap into a partial microactuator assembly having a fluid cavity and a back cavity;
assembling a feed-through flange to the partial microactuator assembly, the feed-through flange defining a sealant cavity;
filling the fluid cavity with a fluid;
sealing the fluid cavity;
attaching lead wires to the microactuator at the sealant cavity; and
filling the sealant cavity with a sealant and curing it.

23. The method of claim 22, further comprising:
placing an O-ring around the microactuator flange.

24. The method of claim 22, further comprising:
evacuating the back cavity.

25. The method of claim 22, further comprising:
filling the back cavity with a gas.
